(19) United States
(12) Patent Application Publication
(10) Pub. No.: US 2026/0241438 A1
(43) Pub. Date: Aug. 20, 2026

(54) METHOD FOR MANUFACTURING NON-STICK PAN LINER

(71) Applicant: JOYOUNG COMPANY LIMITED, Jinan (CN)

(72) Inventors: Zechun ZHU, Jinan (CN); Weimin CUI, Jinan (CN); Gensen ZHANG, Jinan (CN); Xiang WANG, Jinan (CN)

(73) Assignee: JOYOUNG COMPANY LIMITED, Jinan (CN)

(21) Appl. No.: 19/155,924

(22) PCT Filed: Nov. 15, 2023
(86) PCT No.: PCT/CN2023/131713

§ 371 Date: Aug. 12, 2025

(30) Foreign Application Priority Data
Feb. 14, 2023 (CN) 202310112004.8

(51) Int. Cl. B21D 51/22; A47J 36/02; B21D 25/00; B21D 26/021; B21D 35/00

(52) U.S. Cl. CPC B21D 51/22; B21D 25/00; B21D 26/021; B21D 35/007; A47J 36/025

(57) ABSTRACT

A method for manufacturing a non-stick inner pot, including: providing a metal sheet including at least an outer metal layer, a heat equalization layer, and an inner metal layer; performing etching, engraving, or pressing on the inner metal layer, to form an anti-stick array having multiple grooves or protrusions; stretching the metal sheet under a controlled stretching rate to form the inner pot, or first stretching the metal sheet under a controlled stretching rate to form an inner pot blank, and then bulging the inner pot blank under a controlled bulging rate to form the inner pot. A ratio of a thickness of a side wall to that of a bottom wall of the manufactured inner pot ranges from 0.9 to 1.1, and a ratio of a thickness of the outer metal layer to that of the inner metal layer ranges from 0.6 to 1.4.

The present application is the national phase of International Application No. PCT/CN2023/131713, titled “METHOD FOR MANUFACTURING NON-STICK PAN LINER”, filed on Nov. 15, 2023, which claims the priority to Chinese Patent Application No. 202310112004.8, titled “METHOD FOR MANUFACTURING NON-STICK PAN LINER”, filed on Feb. 14, 2023 with the China National Intellectual Property Administration, the entire disclosures thereof are incorporated herein by reference.

### FIELD

The present application relates to the field of kitchen appliances, and in particular to a method for manufacturing a non-stick inner pot.

### BACKGROUND

In a non-stick pot in the conventional technology, protrusions or grooves are provided on its inner surface. A non-stick coating is applied in the grooves, and when a surface of the pot is scraped across by a spatula during cooking, it is less likely for the spatula to scrape the non-stick coating in the grooves, thereby extending the service life of the non-stick coating. During the forming process of the inner pot, methods such as stamping and bulging are generally employed to deform the blank and shape it into the inner pot structure. The inner pot structure may be classified into straight-walled pots or spherical pots based on the shape of the side wall. Specifically, the straight-walled inner pot may be formed through single-step stamping, while the spherical inner pot needs to be formed by a primary stamping process followed by a secondary bulging process. During elongation and extrusion of the blank, a part of the metal sheet located at the center of a die forms a bottom wall of the inner pot, while another part of the metal sheet surrounding the center forms a side wall of the inner pot. In a case where the grooves and protrusions are formed on the surface of the metal sheet, the part of the metal sheet which is stretched faces the problem of deformation of the grooves and protrusions. Excessive deformation may adversely affect the non-stick performance of the inner pot. Eliminating such deformation, however, would increase manufacturing costs and complexity, resulting in low production efficiency and a high defect rate. Deformation mainly occurs on the side wall of the inner pot. Generally, the side wall of a wok or a pan is not the main cooking region, so the requirement for non-stick performance on the side wall of the wok or the pan is relatively lower, consequently, the impact of deformation is negligible. For the inner pots mainly used for holding food, the side wall frequently contact food, necessitating consideration of the impact of deformation. Additionally, the non-stick coating applied within the grooves cannot guarantee complete protection against contact with hard, fine particles. Should such contact occurs, the non-stick performance cannot be ensured. Therefore, achieving a coating-free non-stick solution has become the prevailing industry objective.

### SUMMARY

A method for manufacturing a non-stick inner pot is provided according to the present application to solve at least one of the above issues.

Embodiments are provided in the present application as follows.

A method for manufacturing a non-stick inner pot, including following steps: providing a composite metal sheet comprising at least an outer metal layer, a heat equalization layer, and an inner metal layer; performing etching, engraving, or pressing on a side of the metal sheet where the inner metal layer is located, to form an anti-stick array, where the anti-stick array includes multiple grooves or protrusions; stretching the metal sheet with the anti-stick array under a controlled stretching rate to form the inner pot, or first stretching the metal sheet under a controlled stretching rate to form an inner pot blank, and then bulging the inner pot blank under a controlled bulging rate to form the inner pot. A ratio of a thickness of a side wall to a thickness of a bottom wall of the manufactured inner pot ranges from 0.9 to 1.1, and a ratio of a thickness of the outer metal layer to a thickness of the inner metal layer ranges from 0.6 to 1.4, and one part of the multiple grooves or protrusions, which are deformed by stretching, in the anti-stick array meet a preset requirement.

In one embodiment of the present application, the one part of the multiple grooves or protrusions, which are deformed by stretching, in the anti-stick array are located on the side wall, where a deformation ratio of the one part of the multiple grooves or protrusions in an axial direction of the side wall of the inner pot ranges from 1.1 times to 1.8 times.

In one embodiment of the present application, the one part of the multiple grooves or protrusions, which are deformed by stretching, in the anti-stick array are located on the side wall, where a deformation ratio of the one part of the multiple grooves or protrusions in a circumferential direction of the side wall of the inner pot ranges from 0.5 times to 1.01 times.

In one embodiment of the present application, the remaining part of the multiple grooves or protrusions are located on the bottom wall of the inner pot, where an equivalent diameter D of each of the remaining part of the multiple grooves or protrusions and the thickness H1 of the inner metal layer satisfy the following relationship: 0.08≤D/H1≤3.

In one embodiment of the present application, the one part of the multiple grooves or protrusions, which are deformed by stretching, in the anti-stick array are located on the side wall, where a maximum diameter of each of the one part of the multiple grooves on the side wall of the inner pot which are deformed is smaller than or equal to 1620 micrometers.

In one embodiment of the present application, the one part of the multiple grooves or protrusions, which are deformed by stretching, in the anti-stick array are located on the side wall, and a minimum diameter of each of the one part of the multiple grooves or protrusions on the side wall of the inner pot which are deformed is greater than or equal to 50 micrometers.

In one embodiment of the present application, a ratio of the thickness of the outer metal layer to that of the metal sheet ranges from 0.2 to 0.4.

In one embodiment of the present application, a ratio of the thickness of the inner metal layer to that of the metal sheet ranges from 0.1 to 0.4.

In one embodiment of the present application, a ratio of a thickness of the heat equalization layer to that of the metal sheet ranges from 0.2 to 0.7.

In one embodiment of the present application, the multiple grooves in the anti-stick array are single pits being independent from one another and not in communication with one another, and a portion of the anti-stick array being located at a central region of the bottom wall of the inner pot covers a temperature measurement device.

With the above embodiments, the beneficial effects of the present application are as follows.

In some embodiments of the present application, in order to make the deformation amount of the anti-sticking array be within a preset range, the ratio of the thickness of the side wall to the thickness of the bottom wall of the manufactured inner pot ranges from 0.9 and 1.1, and the ratio of the thickness of the outer metal layer to the thickness of the inner metal layer ranges from 0.6 to 1.4. This enables the area deformation ratio of the region defined by the circumferential direction and the axial direction to be within the range of 1.1 to 0.9. Consequently, the area change in the regions where the grooves or protrusions are located can be kept within a controllable range, thereby ensuring an optimal state of contact between the cooked rice and the anti-sticking array on the side wall of the inner pot.

### BRIEF DESCRIPTION OF THE DRAWINGS

The accompanying drawings described herein are used for providing a further understanding of the present application, and form a part of the present application. Exemplary embodiments of the present application and descriptions thereof are for explaining the present application, and do not constitute any inappropriate limitation to the present application. In the accompanying drawings:

FIG. 1 is a cross-sectional view of a cooking appliance according to an embodiment of the present application;

FIG. 2 is a cross-sectional view of an inner pot according to an embodiment of the present application;

FIG. 3 is a top view of the inner pot according to the embodiment of the present application;

FIG. 4-1 is an electron micrograph of a cross-section taken along a thickness direction of a bottom wall of an inner pot in a specific embodiment of the present application;

FIG. 4-2 is an electron micrograph of a cross-section taken along a thickness direction of a side wall of the inner pot in the specific embodiment of the present application;

FIG. 5-1 is an electron micrograph of an anti-stick array on the bottom wall of the inner pot in the specific embodiment of the present application;

FIG. 5-2 is an electron micrograph of an anti-stick array on the side wall of the inner pot in the specific embodiment of the present application;

FIG. 6 is a view of distribution of regions where anti-stick arrays are formed on a metal sheet according to a second embodiment of the present application;

FIG. 7-1 is a partially enlarged view of grooves on region S1 according to a second embodiment of the present application; and

FIG. 7-2 is a partially enlarged view of grooves on region S2 according to the second embodiment of the present application.

Reference numerals:

| | | | |
|---|---|---|---|
| 10 | pot body, | 105 | heating device, |
| 20 | pot lid, | | |
| 30 | inner pot, | 31 | bottom wall, |
| 32 | side wall, | 33 | anti-stick array, |
| 301 | cooking chamber, | 321 | outer metal layer, |
| 322 | heat equalization layer, | 323 | inner metal layer. |

### DETAILED DESCRIPTION OF THE EMBODIMENTS

To illustrate the overall concept of the present application more clearly, detailed description will made hereinafter through examples in conjunction with the accompanying drawings in the specification.

Various specific details are set forth in the following description to facilitate a full understanding of the present application. The present application may be implemented in manners different from those described herein. Therefore, the present application is not limited by the specific embodiments disclosed hereinafter.

In the description of the present application, it should be understood that an orientation or positional relationship indicated by terms such as “top”, “bottom”, “inner”, “outer”, “axial”, “radial”, “circumferential”, or the like is defined based on orientation or positional relationship in the accompanying drawings, which is intended to facilitate description of the present application and to simplify the description, rather than to indicate or imply that a device or element referred to must have a particular orientation or has to be constructed and operated in a particular orientation, and therefore should not be construed as limiting the present application.

In the present application, unless otherwise explicitly specified and defined, terms such as “mount”, “link”, “connect”, and “fix” should be understood in a broad sense. For example, it may refer to a fixed connection, a detachable connection, or an integral connection; it may refer to a mechanical connection, an electrical connection, or a communication connection; it may refer to a direct connection, an indirect connection through an intermediate media, an internal communication between two elements, or an interaction relationship between the two elements. The specific meanings of the above terms in the present application may be understood according to specific situations.

In the present application, unless otherwise explicitly specified and defined, the first feature being “above” the second feature or “below” the second feature indicates that the first feature is in direct contact with the second feature or in indirect contact with the second feature via an intermediate medium. In the description of the specification, descriptions referring to terms such as “an embodiment”, “some embodiments”, “examples”, “specific examples”, or “some examples” mean that the specific features, structures, materials, or characteristics described in conjunction with the embodiment or example are included in at least one embodiment or example of the present application. In this specification, the illustrative expressions of the above terms are not necessarily directed to a same embodiment or example. Furthermore, the specific features, structures, materials or characteristics described may be combined in any one or more embodiments or examples in a suitable manner.

A method for manufacturing a non-stick inner pot is provided according to the present application, and in particular relates to a method for manufacturing a coating-free inner pot for rice cooking. The inner pot is mainly used in a rice cooking appliance, which may be a rice cooker or a pressure cooker. In some other embodiments, it may be other cooking appliances with rice cooking functions. A coating-free inner pot for rice cooking is further provided according to the present application, which can be manufactured through the above manufacturing method.

The cooking appliance adopts a non-coated or coating-free inner pot for rice cooking. Most of the existing inner pots are coated inner pots, that is, a Teflon (scientific name polytetrafluoroethylene, PTFE) coating is applied on an inner surface of the inner pot. The coating-free inner pot proposed in the present application, in contrast to the above-mentioned coated inner pot, does not have a coating applied onto its base material. Therefore, an inner side wall of the inner pot is a metal layer that is in direct contact with food. The metal layer may be made of stainless steel. During cooking, food is in direct contact with the metal layer of the inner pot for cooking, thereby eliminating dietary and health problems caused by coating peeling of the coated inner pot and the coating itself.

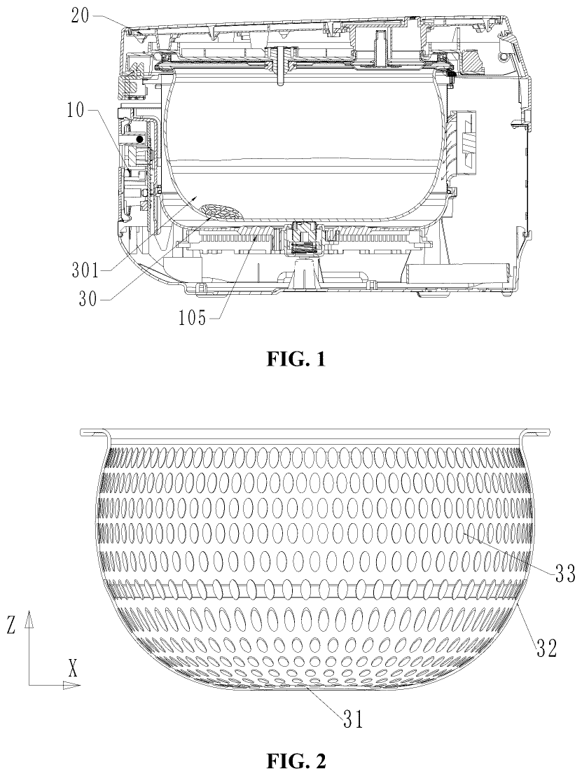

Referring to FIG. 1, a rice cooker is illustrated, including a pot body 10, a pot lid 20, and an inner pot 30. The inner pot 30 is placed inside the pot body 10, with its inner side being in contact with rice via an inner metal layer 323. The pot lid 20 is covered on the pot body 10. The pot body 10 is provided with a heating device 105 for heating the inner pot 30. During the cooking process, a mixture of rice and water is added to a cooking chamber 301 in the inner pot 30, and heated by the heating device 105 at the bottom of the inner pot 30, and thus rice cooking is completed.

In the present application, an anti-stick array is formed on the inner pot through etching, engraving, or pressing, to achieve non-stick properties. The anti-stick array includes multiple grooves or protrusions. When rice comes into contact with the protrusions, the presence of the protrusions or the grooves reduces the contact area between the rice and the inner pot and alters the contact angle between the rice and the inner pot, thereby achieving non-stick rice cooking. During manufacturing of the inner pot, the grooves or the protrusions are first formed on a metal sheet, which is then stretched into a cylindrical structure through a mold.

The inner pot in the present application employs a composite metal sheet. As shown in FIGS. 4-1 and 4-2, the metal sheet includes at least an outer metal layer 321, a heat equalization layer 322, and an inner metal layer 323 that are bonded together. The inner metal layer 323 is located on a side of the inner pot used for holding rice, which meets food-grade hygiene requirements. The inner metal layer 323 may be made of stainless steel. The heat equalization layer 322 is made of a material with high thermal conductivity to facilitate rapid heat conduction, to ensure uniform heating of the inner pot. The heat equalization layer 322 may be made of aluminum. The outer metal layer 321 is located on an outer side of the inner pot and configured to generate heat by itself under the influence of a magnetic field or protect the heat equalization layer 322. The outer metal layer 321 may also be made of stainless steel. In some other embodiments, the metal sheet may include at least a heat equalization layer 322 and an inner metal layer 323 that are bonded together.

In a specific embodiment of the present application, as shown in FIGS. 1, 2, and 3, the inner pot 30 includes a bottom wall 31, a side wall 32, and a cooking chamber 301. The cooking chamber 301 is open at the top. The side wall 32 has a depth direction extending from the bottom wall 31 toward the opening of the cooking chamber 301 and a circumferential direction extending along a circumference of the bottom wall 31. One side of the inner pot 30 where the inner metal layer 323 is located is etched, engraved, or pressed to form an anti-stick array 33, which includes multiple grooves or protrusions. Etching is a process that utilizes the erosion effect on the surface of the inner metal layer 323 to metal from the surface of the stainless steel. Engraving may be laser engraving or mechanical engraving. Laser engraving is a processing technology based on numerical control technology and using laser as a medium, achieves processing purpose by causing instantaneous melting and vaporization of the processed material under laser irradiation. Pressing involves applying external force to the sheet through a stamping device to cause the sheet to be deformed under the direct deformation force within a mold. Etching and engraving are subtractive manufacturing methods, while pressing is a deformation manufacturing method.

In one specific embodiment of the present application, in order to control the deformation of the grooves and the protrusions within a preset range, a method for manufacturing a non-stick inner pot is provided as follows. This method is primarily realized by controlling changes in the thickness of the inner pot, as detailed below.

The first embodiment is described as follows. A metal sheet including at least an outer metal layer 321, a heat equalization layer 322, and an inner metal layer 323 bonded together is provided. An anti-stick array 33, including multiple grooves or protrusions, is formed on the inner metal layer 323 through etching, engraving, or pressing. The metal sheet with the anti-stick array 33 is then stretched under a controlled stretching rate to form an inner pot; in one embodiment, the metal sheet with the anti-stick array is first stretched into an inner pot blank under a controlled stretching rate, and then the inner pot blank is bulged to form an inner pot under a controlled bulging rate. A ratio of the thickness of the side wall to the thickness of the bottom wall of the manufactured inner pot is in a range from 0.9 to 1.1, and a ratio of the thickness of the outer metal layer 321 to the thickness of the inner metal layer 323 is in a range from 0.6 to 1.4, to ensure that the grooves or protrusions in the anti-stick array 33 to be within a preset range.

In the first and second embodiments, as well as other specific embodiments of the present application, a percentage of a length increased by plastic elongation to an original length of the sample is referred to as the stretching rate, elongation rate, or extending rate. Taking 304 stainless steel as an example, it has an elongation rate exceeding 40%, meaning that, 1 mm of the stainless steel can be stretched by at least 0.4 mm. To successfully manufacture the inner pot in the present application, the stretching rate should be controlled not to exceed the maximum stretching rate of the metal material used during the stretching process, to avoid material breakage and necking issues. Under this premise, and with the presence of the anti-stick array 33, further consideration should be given to the potential weakening of the anti-stick effect due to stretching deformation. During stretching, the extension of the metal sheet causes deformation of the anti-stick array 33, specifically, an axial dimension of the grooves in the anti-stick array 33 is increased, while a circumferential dimension of the grooves may either decrease or increase. In this case, the grooves deviate from their original undeformed shape, altering the optimal contact state between the rice and the inner pot surface, resulting in poor anti-stick performance for rice on the side wall of the inner pot.

In the first and second embodiments, as well as other specific embodiments of the present application, based on the fundamental principle that the density of the metal material remains constant after plastic deformation and knowing that the mass remains unchanged before and after deformation, to maintain consistent density, the volume must also remain consistent before and after deformation (volume=length×width×thickness). Specifically, a length direction is defined as an axial direction of the side wall of the inner pot, a width direction is defined as a circumferential direction of the side wall of the inner pot, and a thickness direction is defined as the wall thickness direction of the side wall of the inner pot. Thus, the deformation relationships in the axial, circumferential, and lateral directions of the side wall of the inner pot can be determined. The magnitude of deformation in the thickness direction depends on deformation magnitudes in the axial and circumferential directions. In other words, the magnitude of deformation in the thickness direction can be used to indirectly reflect the deformation magnitudes in the axial and circumferential directions, to assess the deformation of the anti-stick array 33 in the axial and circumferential directions, to prevent excessive deformation of the anti-stick array 33.

In the first and second embodiments, as well as other specific embodiments of the present application, during a stamping process, the magnitude of deformation in the wall thickness direction can be controlled by the size and shape of the cavity between the front and rear molds of a die or by the bulging pressure. Compared to directly controlling the deformation rates in the circumferential and axial directions of the anti-stick array 33, controlling deformation of the anti-stick array 33 through dimension in the thickness direction aligns with the key parameter control logic in the stamping process. In this way, controlling is simple and convenient, thus ensuring consistent product forming, high product quality, and easy control of the deformation amount of the anti-stick array 33, which prevents excessive deformation, and thereby ensuring the anti-stick effect on the side wall of the inner pot. Specifically, in the first embodiment of the present application, in order to keep the deformation of the anti-stick array 33 within the preset range, the ratio of the thickness of the side wall to the thickness of the bottom wall of the manufactured inner pot is between 0.9 and 1.1. This ensures that the area deformation ratio of the region defined by the circumferential direction and the axial direction is between 1.1 and 0.9, to keep the area change of the region where the grooves or protrusions are located within a controllable range, and thereby maintaining a good contact state between the rice and the anti-stick array 33 on the side wall of the inner pot. Preferably, the ratio “a” of the thickness of the side wall to the thickness of the bottom wall of the inner pot is in a range from 1.01 to 1.1. Assuming that proportions of reduction and increase in the axial direction are the same as those in the circumferential direction, the relationship between the deformation rate “X” and “a” can be expressed as: 1−X²=1/a, yielding Xϵ[10%, 30%]. This ensures that the reduction rate in the circumferential direction is around 10% at the minimum, and around 30% at the maximum, to prevent the grooves from turning into narrow slits.

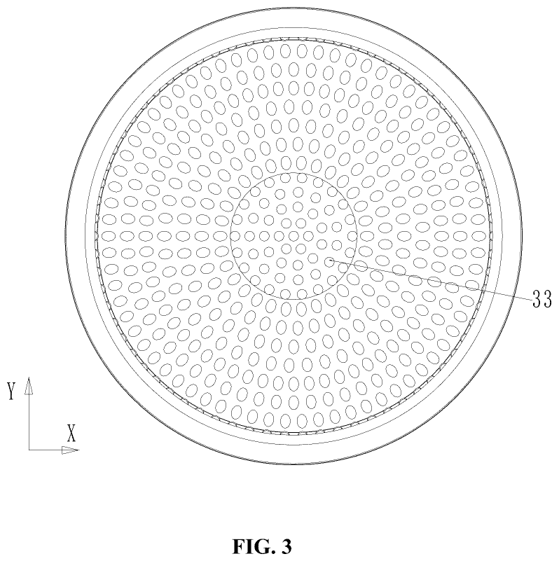

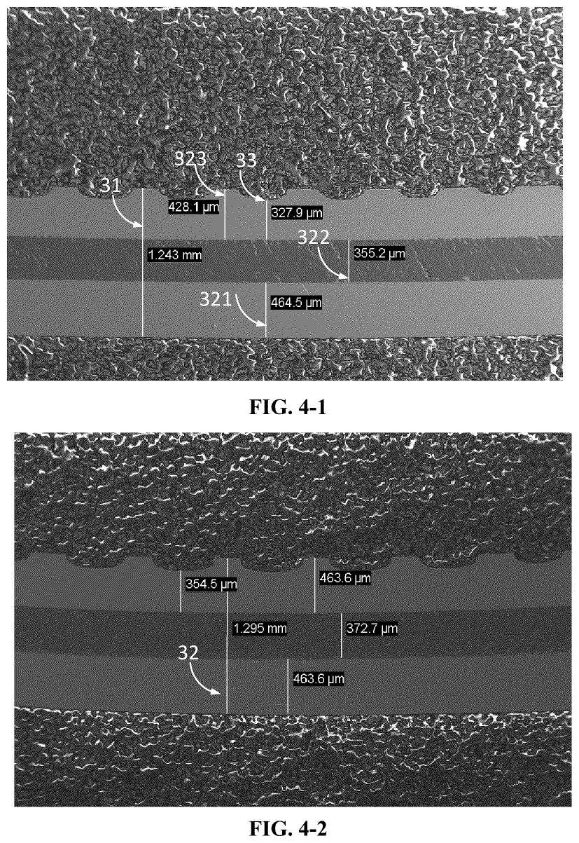

In the first embodiment of the present application, the ratio “a” of the thickness of the side wall to the thickness of the bottom wall of the inner pot may also be 0.9, 0.91, 0.92, 0.93, 0.94, 0.95, 0.96, 0.97, 0.98, 0.99, 1, 1.02, 1.03, 1.04, 1.05, 1.06, 1.07, 1.08, or 1.09, ensuring that the area change of the region where the grooves or protrusions are located remains within a reasonable range. FIG. 4-1 shows a magnified cross-sectional view of the bottom wall of the inner pot under an electron microscope, where the thickness of the bottom wall is 1.243 mm. FIG. 4-2 shows a magnified cross-sectional view of the side wall of the inner pot under an electron microscope, where the thickness of the side wall is 1.295 mm. A ratio of the thickness of the side wall to the thickness of the bottom wall is 1.04.

In the first and second embodiments, as well as other specific embodiments of the present application, during the stamping process, any regions subjected to excessive tensile stress will experience severe localized thinning or even cracking, and any regions subjected to excessive compressive stress will lose stability and wrinkle if the compressive stress exceeds the critical level. In the composite metal sheet, during deformation of the inner pot, the outer metal layer 321 closer to the inner side is more prone to thinning due to tensile stress, while the inner metal layer 323 is more prone to thickening due to compressive stress. To avoid excessive deformation in thickness of the composite metal sheet, in the first embodiment of the present application, the thickness difference between the inner metal layer and the outer metal layer 321 should not be too large, and their thicknesses should be kept as consistent as possible, to prevent the grooves from becoming excessively deep due to excessive compressive stress in the thickness direction of the inner metal layer 323. The ratio of the thickness of the outer metal layer to the thickness of the inner metal layer 323 may range from 0.6 to 1.4. If the inner metal layer 323 is too thick and the outer metal layer 321 is too thin, the outer metal layer 321 is more ductile than the inner metal layer 323, resulting in deeper grooves in the inner metal layer 323. Conversely, if the inner metal layer 323 is too thin and the outer metal layer 321 is too thick, the inner metal layer 323 is more ductile than the outer metal layer 321, resulting in shallower grooves in the inner metal layer 323. Both deepening and shallowing of the grooves affect the optimal contact state between the rice and the anti-stick array 33, so the grooves of the anti-stick array 33 should be maintained within a reasonable deformation range, to ensure the non-stick performance of side wall of the inner pot.

In the first embodiment of the present application, the specific ratio of the thickness of the outer metal layer to the thickness of the inner metal layer 323 may be 0.6, 0.7, 0.8, 0.9, 1, 1.1, 1.2, 1.3, or 1.4. The specific thickness of the inner metal layer 323 may range from 0.35 mm to 0.8 mm. The ratio of the outer metal layer to the inner metal layer shown in FIG. 4-1 is 464.5 μm/428.1 μm=1.08, and the ratio of the outer metal layer to the inner metal layer shown in FIG. 4-2 is 463.6 μm/463.6 μm=1.

In the first and second embodiments, as well as other specific embodiments of the present application, the bottom wall of the inner pot refers to a substantially flat portion at the bottom of the inner pot, and the side wall of the inner pot refers to a wall portion connected to the flat portion at the bottom of the inner pot and extending toward the pot opening, including but not limited to an arc-shaped side wall for upward arc transition. If the inner pot is a straight type inner pot (referred to as the straight inner pot), the inner pot further includes a vertical side wall portion extending toward the pot opening. If the inner pot is a spherical type inner pot (referred to as the spherical inner pot), the inner pot further includes a spherical wall portion extending toward the pot opening and protruding toward the outer side of the inner pot. The inner pot shown in FIG. 2 is a spherical inner pot.

In the first embodiment of the present application, different manufacturing processes will be adopted depending on the shape of the inner pot. For the straight inner pot, the manufacturing process is as follows:
S01: performing etching, engraving, or pressing on one side of the metal sheet where the inner metal layer is located to form an anti-stick array; and
S03: stretching the metal sheet with the anti-stick array under a controlled stretching rate to form an inner pot.

For the spherical pot, the manufacturing process is as follows:
S02: performing etching, engraving, or pressing on one side of the metal sheet where the inner metal layer is located, to form an anti-stick array;
S04: stretching the metal sheet under a controlled stretching rate to form an inner pot blank; and
S06: bulging the inner pot blank under a controlled bulging rate to form an inner pot.

The inner pot blank may be formed through a primary stamping process through a stamping machine, and then a secondary bulging process is performed through a hydroforming machine.

In the first embodiment of the present application, the grooves or protrusions in the anti-stick array 33 that are deformed by stretching should be within a preset range, which refers to the area change rate of the region where the grooves or protrusions are located, the dimensional change rate in the circumferential direction of the grooves or protrusions, or the dimensional change rate in the axial direction of the grooves or protrusions.

Specifically, in the first embodiment of the present application, the preset requirement may be as follows.

The grooves or protrusions in the anti-stick array 33, which are deformed by stretching, are located on the side wall, where a deformation ratio “b” in the axial direction of the side wall of the inner pot ranges from 1.1 to 1.8 times. This deformation ratio is defined as the ratio of the axial dimension of the anti-stick array 33 on the side wall of the inner pot after stretching to a corresponding dimension (pre-axial dimension) of the anti-stick array 33 on the bottom wall of the inner pot.

The axial dimension increases during the stretching process, and the axial deformation should not be excessive, otherwise the width of grooves may be too large, resulting in a poor anti-stick performance for rice.

As mentioned above, in this embodiment, for the grooves or protrusions in the anti-stick array 33, which are deformed by stretching are located on the side wall, where the deformation ratio “c” in the circumferential direction of the side wall of the inner pot ranges from 0.5 to 1.01 times. This deformation ratio is defined as the ratio of the circumferential dimension of the anti-stick array 33 on the side wall of the inner pot after stretching to the corresponding dimension (pre-circumferential dimension) of the anti-stick array 33 on the bottom wall of the inner pot.

Based on the principle of constant volume before and after deformation, with a thickness deformation of 10%, the axial deformation should not exceed 1.8 times to avoid a circumferential shrinkage rate greater than 50%. If the circumferential shrinkage rate is too high and the axial elongation is too great, the grooves on the side wall become slender to form slits, resulting in easier clogging of the grooves with starch particles or other food residues, thereby making the pot wall difficult to clean thoroughly. Over time, accumulated grime will affect food hygiene and lead to flavor transfer, which degrades the user experience. The axial deformation should be greater than or equal to 1.1 times to ensure that the circumferential elongation rate does not exceed 1%, to prevent the circumferential and axial dimensions of the grooves from becoming excessively large. If rice grains can easily fit into the grooves, they may be heated three-dimensionally in the grooves, causing the rice starch to gelatinize more easily, which makes the rice be sticky and difficult to be removed, resulting in poor anti-stick performance.

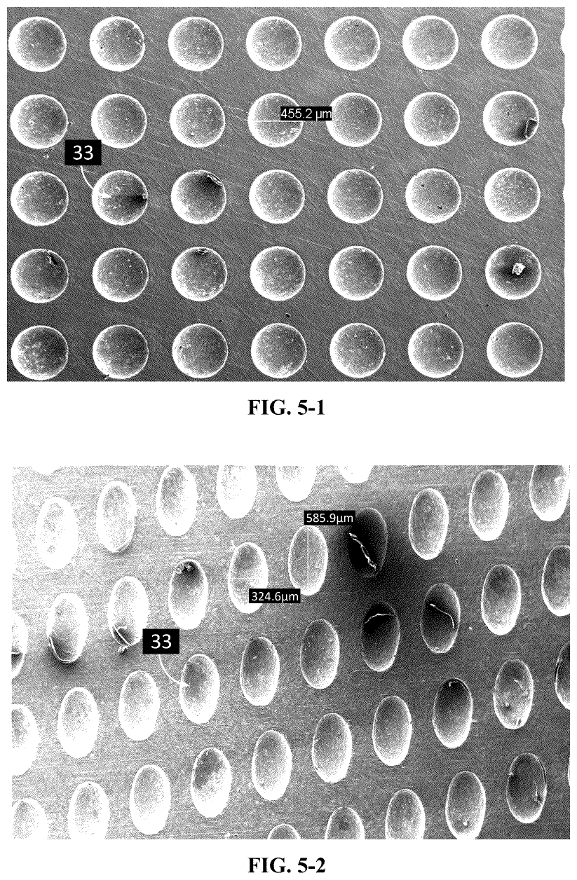

In the first embodiment of the present application, the deformation ratio “b” may specifically be 1.1, 1.2, 1.3, 1.4, 1.5, 1.6, 1.7, or 1.8, and the deformation ratio “c” may specifically be 0.5, 0.6, 0.7, 0.8, 0.9, 1, or 1.01. The anti-stick array 33 on the bottom wall of the inner pot may be the part of the anti-stick array 33 covering the temperature measurement device in the central region of the bottom wall. FIG. 5-1 is an electron micrograph of the anti-stick array on the bottom wall of the inner pot, where a diameter of the groove is 455.2 μm. FIG. 5-2 is an electron micrograph of the anti-stick array on the side wall of the inner pot, where the axial dimension of the groove is 585.9 μm and the circumferential dimension of the groove is 324.6 μm. Thus, the specific value of the deformation ratio “b” is 585.9/455.2=1.287, and the specific value of the deformation ratio “c” is 324.6/455.2=0.713.

In another specific embodiment of the present application, to control the deformation of the grooves and protrusions within a preset range, a method for manufacturing a coating-free rice inner pot is provided, which is mainly realized through the principle of pre-deformation. The specific method is as follows.

The second embodiment is described as follows. A metal sheet including at least an inner metal layer 323 and a heat equalization layer 322 bonded together is provided. An anti-stick array 33, including multiple grooves and protrusions, is formed on the inner metal layer 323 through etching, engraving, or pressing. The metal sheet with the anti-stick array 33 is stretched to form an inner pot, in one embodiment, the metal sheet with the anti-stick array is first stretched into an inner pot blank, and then the inner pot blank is bulged to form the inner pot. When etching, engraving, or pressing the anti-stick array 33, comparing one part of the grooves and protrusions, which are located on one portion of the metal sheet used to form the side wall of the inner pot with the remaining part of the grooves and protrusions, which are located on the remaining portion of the metal sheet used to form the bottom wall of the inner pot, the pre-axial dimension of the one part of the grooves and protrusions is smaller than the pre-axial dimension of the remaining part of the grooves and protrusions; and the pre-circumferential dimension of the one part of the grooves and protrusions is larger than the pre-circumferential dimension of the remaining part of the grooves and protrusions, and the grooves and protrusions in the anti-stick array 33 which are deformed by stretching are within the preset range.

The second embodiment of the present application is similar to the first embodiment. Different manufacturing processes will be adopted depending on the shape of the inner pot. For a straight inner pot, the manufacturing process is as follows:
S01: performing etching, engraving, or pressing on one side of the metal sheet where the inner metal layer is located to form an anti-stick array;
S03: stretching the metal sheet with the anti-stick array to form an inner pot.

For a spherical inner pot, the manufacturing process is as follows:
S02: performing etching, engraving, or pressing on one side of the metal sheet where the inner metal layer is located, to form an anti-stick array;
S04: stretching the metal sheet to form an inner pot blank; and
S06: bulging the inner pot blank to form an inner pot.

The inner pot blank may be formed through a primary stamping process through a stamping machine, and then a secondary bulging process is performed through a hydroforming machine.

During the process of plastic deformation of the metal, the grooves and the protrusions on the side wall of the inner pot are deformed. After deformation, the optimal contact state between the rice and the anti-stick array 33 is changed, resulting in poor anti-stick performance for the rice on the side wall of the inner pot.

Firstly, the thickness of the side wall of the inner pot may be controlled to remain within a controllable range before and after deformation, to obtain the area deformation ratio between the regions in the other two directions of the anti-stick array 33. Based on possible deformation parameters, the shape and dimensions of the grooves and protrusions of the anti-stick array 33 may be pre-deformed in a reversed manner before stretching, and the deformation of the grooves on the side wall of the manufactured inner pot is controlled within the preset range.

Specifically, when etching, engraving, or pressing the anti-stick array, comparing one part of the grooves and protrusions, which are located on one portion of the metal sheet used to form the side wall of the inner pot with the remaining part of the grooves and protrusions, which are located on the remaining portion of the metal sheet used to form the bottom wall of the inner pot, the pre-axial dimension of the one part of the grooves and protrusions is smaller than the pre-axial dimension of the remaining part of the grooves and protrusions, while the pre-circumferential dimension of the one part of the grooves and protrusions is larger than the pre-circumferential dimension of the remaining part of the grooves and protrusions.

The pre-axial dimension means that after the inner pot is formed, this dimension becomes the axial dimension on the surface of the side wall of the inner pot, and the pre-circumferential dimension means that after the inner pot is formed, this dimension becomes the circumferential dimension on the surface of the side wall of the inner pot. For example, before stretching, taking the center point of the sheet forming as a reference, generally, the dimension of each of the grooves in the radial direction passing through the center point is the pre-axial dimension, and the dimension perpendicular to this radial direction is the pre-circumferential dimension.

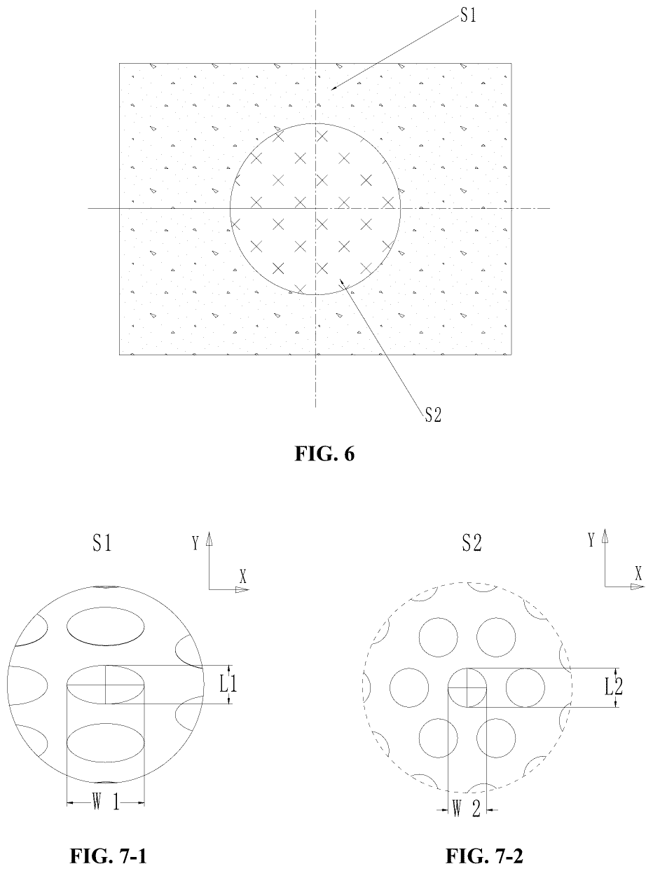

FIG. 6 shows a metal sheet before stretching. When performing the process of step S01 or S02 on this metal sheet, assuming that region S2 is the part that forms the bottom wall of the inner pot after subsequent stretching, and region S1 is the part that forms the side wall of the inner pot after subsequent stretching, the shape of the grooves in region S1 is pre-deformed. As shown in FIGS. 7-1 and 7-2, a case where the grooves are circular-shaped is taken as an example, the circular grooves are provided in region S2, which forms the bottom wall of the inner pot, with dimensions W2 and L2 both being diameters, while elliptical grooves are formed in region S1, which forms the side wall of the inner pot, where a major axis of the ellipse is approximately in the pre-circumferential direction and the minor axis of the ellipse is approximately in the pre-axial direction.

After the inner pot is manufactured, a pre-axial dimension L1 of the pre-deformed elliptical grooves is increased while a pre-circumferential dimension W1 thereof is decreased, which avoids significant difference between the final axial and circumferential dimensions of the grooves on the side wall of the inner pot and the dimensions (W2, L2) of the grooves on the bottom wall of the inner pot, to make the deformation of the grooves on the side wall be kept within the preset range, and thereby ensuring a good anti-stick effect.

In the second embodiment of the present application, the preset range refers to the ratio of the axial dimension of the grooves on the side wall of the inner pot to the dimension of the grooves on the bottom wall of the inner pot after stretching, where the ratio ranges from 0.9 to 1.25.

The axial dimension increases during the stretching process. The axial deformation should not be excessive, otherwise the width of the grooves may be too large, resulting in poor anti-stick performance for rice. After the pre-deformation treatment, there's no big difference between shapes of the grooves on the side wall of the inner pot and the grooves on the bottom of the inner pot, thereby ensuring a good anti-stick effect of the inner pot for rice.

The preset range refers to the ratio of the circumferential dimension of the grooves on the side wall of the inner pot to the dimension of the grooves on the bottom wall of the inner pot after stretching, where the ratio ranges from 0.8 to 1.01.

The circumferential dimension is likely to shrink during the deformation process. Similarly, after the pre-deformation treatment, there's no big difference in the circumferential dimension between the grooves on the side wall of the inner pot and the grooves on the bottom wall of the inner pot, thereby ensuring a good anti-stick effect for rice.

In the second embodiment of the present application, the ratio of the axial dimension of the grooves to the dimension of the grooves on the bottom wall of the inner pot may specifically be 0.9, 0.95, 1, 1.05, 1.1, 1.15, 1.2, or 1.25. The ratio of the circumferential dimension of the grooves to the dimension of the grooves on the bottom wall of the inner pot may specifically be 0.8, 0.85, 0.9, 0.95, 1, 1.05, 1.1, 1.15, 1.2, or 1.25.

Similarly, the thickness of the side wall of the inner pot is kept within a controllable range before and after deformation, which facilitates the pre-deformation of the pre-axial and pre-circumferential dimensions of the anti-stick array 33 before stretching.

Therefore, before stretching, the depth of the one part of the grooves or protrusions, which are located on the one portion of the metal sheet used to form the side wall of the inner pot is equal to the depth of the remaining part of the grooves or protrusions, which are located on the remaining portion of the metal sheet used to form the bottom wall of the inner pot.

By making the depth of the one part of the grooves be equal to the depth of the remaining part of the grooves and protrusions before stretching, no pre-deformation is made to the thickness, which facilitates the pre-deformation of the pre-axial and pre-circumferential dimensions and reduces the difficulty of pre-deformation.

The preset range refers to the ratio of the depth of the grooves on the side wall of the inner pot to the depth of the grooves on the bottom wall of the inner pot after stretching, where the ratio ranges from 0.9 to 1.1.

In the pressing process, the magnitude of deformation in the depth direction of the groove may be controlled by the size and shape of the cavity between the front and rear molds of the die or by the bulging pressure, which is convenient, simple, and efficient.

In the second embodiment of the present application, the ratio of the depth of the grooves on the side wall to the depth of the grooves on the bottom wall of the inner pot may specifically be 0.9, 0.95, 1, 1.05, or 1.1. As shown in FIGS. 4-1 and 4-2, the depth of the grooves on the bottom wall of the inner pot is 428.1−327.9=100.2 μm and the depth of the grooves on the side wall of the inner pot is 463.6−354.5=109.1 μm, with the specific ratio of the above two depths is 1.08.

The further the first embodiment and the second embodiments, and some other embodiments of the present application are illustrated as follows.

An equivalent diameter of the grooves or protrusions located on the bottom wall of the inner pot is defined as D, and the equivalent diameter D and the thickness H1 of the inner metal layer 323 satisfy the following relationship: 0.08≤D/H1≤3.

The ratio of the equivalent diameter D to the thickness H1 represents the number of grooves per unit thickness. If there are too many grooves per unit thickness, the void fraction per unit thickness may be too high. Under a certain amount of heat per unit thickness, the higher the void fraction is, the lower the heat transfer efficiency is. Conversely, if there are too few grooves per unit thickness, the void fraction per unit thickness may be too low, causing the rice to be in closer contact with the pot wall, receiving more heat, and thus more prone to sticking to the inner pot. Therefore, in the specific embodiment of the present application, the number of grooves per unit thickness is not less than 0.08 and not more than 3, to balance heat transfer efficiency and the sticking problem.

In the first, second and some other specific embodiments of the present application, specific values for D/H1 may also be 0.08, 0.53, 0.98, 1.43, 1.88, 2.33, 2.78, or 3. Referring to FIGS. 4-1 and 5-1, the equivalent diameter D is 455.2 μm, and H1 is 428.1 μm, resulting in a ratio of 1.06.

In addition to the deformation of the anti-stick array 33 between the side wall and the bottom wall of the inner pot being within a preset ratio range, the following preset range are also included.

In some specific embodiments of the present application, the grooves or protrusions in the anti-stick array 33 which are deformed by stretching are located on the side wall, and the maximum diameter of the deformed grooves on the side wall of the inner pot is not greater than 1620 micrometers. As shown in FIG. 5-2, the maximum diameter of the deformed grooves is 585.9 μm.

Generally, the width of a rice grain is about 2 mm, and its expansion rate after absorbing water is approximately 1.5 to 2 times. Therefore, the width of the cooked rice grain after absorbing water is not less than 3 mm. To ensure an anti-stick effect and prevent rice from getting stuck, the maximum diameter of the grooves after deformation is not greater than 1620 micrometers. The size of the groove after stretching is larger than the original size, and may be larger than the size of the rice grains. In this case, the rice grains are more likely to get stuck in the deformed grooves. As mentioned earlier, the inner pot generally elongates in the axial direction and shortens in the circumferential direction during deformation, causing the deformed grooves to easily turn into slits. Based on this, if the deformation size exceeds the upper limit, the rice grains may get stuck in the grooves. The rice grains stuck in the grooves are three-dimensionally heated, which causes the rice starch more prone to burning and sticking to the inner pot.

The grooves or protrusions in the anti-stick array 33 which are deformed by stretching are located on the side wall, and the minimum diameter of the grooves or protrusions on the side wall of the inner pot after deformation is not less than 50 micrometers. As shown in FIG. 5-2, the minimum diameter of the deformed grooves is 324.6 μm.

To ensure the anti-stick performance, there should be a minimum value of the diameter of the groove after circumferential shrinkage, for example, the minimum value is 100 micrometers. If it is not greater than this value, the grooves will be too narrow to provide the anti-stick effect. Moreover, the slits will be difficult to clean, the food hygiene will be affected by the accumulated dirt, the inner surface of the inner pot is prone to blackening, with a strong odor and flavor transfer may easily occur.

The equivalent diameter D of the grooves or protrusions on the bottom wall of the inner pot is not greater than 900 micrometers and not less than 100 micrometers. This ensures that during the rice cooking process of the cooking appliance, the deformation of the grooves or protrusions in the anti-stick array 33 on the side wall of the inner pot is within a reasonable range, neither too large nor too small, to ensure the anti-stick performance of the inner pot.

In the embodiments of the present application, the thickness of the metal sheet ranges from 1 mm to 5 mm, with a thickness variation controlled at around ±10%. For example, for a metal sheet with a thickness of 3 mm, the thickest part after stretching has a thickness of 3.32 mm.

As the thickness of the metal sheet increases, so does its mass. Correspondingly, the thickness of the outer metal layer 321 may also be increased to enhance the protective capacity of the inner pot. In some specific embodiments of the present application, the ratio of the thickness of the outer metal layer 321 to the thickness of the metal sheet is 0.2 to 0.4. The specific value of this ratio may be 0.2, 0.25, 0.3, 0.35, or 0.4. As shown in FIG. 4-1, the above ratio for the bottom wall of the inner pot is 464.5/1243=0.37, and in FIG. 4-2, the above ratio for the side wall of the inner pot is 463.6/1295=0.36.

As the thickness of the metal sheet increases, the thickness of the inner metal layer 323 may also be increased. Compared to the outer metal layer 321, the inner metal layer 323 may be thinner. The ratio of the thickness of the inner metal layer 323 to the thickness of the metal sheet is 0.1 to 0.4. The specific value of this ratio may be 0.1, 0.15, 0.2, 0.25, 0.3, 0.35, or 0.4. As shown in FIG. 4-1, the above ratio for the bottom wall of the inner pot is 428.1/1243=0.34, and as shown in FIG. 4-2, the above ratio for the side wall of the inner pot is 463.6/1295=0.36.

Generally, as the metal sheet becomes thicker, the capacity also increases, leading to higher heat transfer requirements. In this case, the heat equalization layer 322 may be thicker. The ratio of the thickness of the heat equalization layer 322 to the thickness of the metal sheet ranges from 0.2 to 0.7. The specific value of this ratio may be 0.2, 0.25, 0.3, 0.35, 0.4, 0.45, 0.5, 0.55, 0.6, or 0.65. As shown in FIG. 4-1, the above ratio for the bottom wall of the inner pot is 355.2/1243=0.28, and as show in FIG. 4-2, the above ratio for the side wall of the inner pot is 372.7/1295=0.28.

For a metal sheet with a thickness of 1.5 mm, the thicknesses of the inner metal layer 323, the heat equalization layer 322, and the outer metal layer 321 are 0.5 mm, 0.5 mm, and 0.5 mm, respectively. For a metal sheet with a thickness of 3 mm, the thicknesses of the inner metal layer 323, the heat equalization layer, and the outer metal layer 321 are 0.8 mm, 1.6 mm, and 0.6 mm, respectively.

In some specific embodiments of the present application, the grooves in the anti-stick array 33 are single pits being independent from one another and not in communication with one another, and a portion of the anti-stick array 33 being located at a central region of the bottom wall of the inner pot covers the temperature measurement device. The grooves are single pits being independent from one another and not in communication with one another, and the grooves have certain water retention capability, to maintain a water film and thus possess anti-stick properties. The anti-stick array 33 located at the central region of the bottom wall of the inner pot covers the temperature measurement device, which is generally located on a flat surface to ensure temperature measurement accuracy. Therefore, the temperature measurement device is located at the bottom wall of the inner pot, meaning that the deformation of the anti-stick array 33 in this area is minimal, and its dimensions can serve as a source for the pre-axial and pre-circumferential dimensions before deformation. It can also serve as a source for the dimensions of the grooves before deformation in the manufactured inner pot. For example, by obtaining the dimensions of the grooves at the region covering the temperature measurement device and comparing them with the dimensions of the grooves on the side wall of the inner pot, the desired data can be obtained.

In some embodiments of the present application, the grooves have basic shapes such as circular, hexagonal, square, or rectangular shape. The arrangement of the grooves in the inner pot follows basic array patterns such as rectangular or circular arrays. The array patterns of the grooves and protrusions in the anti-stick array 33 are rectangular or circular arrays. For the above embodiments, it should be understood that the basic shapes of the grooves may also be other shapes, and the array patterns may also be other patterns. Different shapes and array patterns can be freely combined. For example, circular rice paste grooves can be arranged in a rectangular array.

For parts not mentioned in the present application, the conventional technology can be adopted or referenced for implementation.

The embodiments are described in this specification in a progressive manner. Various embodiments may refer to each other for the same or similar parts, and each embodiment places emphasis on the difference from other embodiments.

The above descriptions are only embodiments of the present application and are not intended to limit the present application. Various modifications and variations to the present application. Any modifications, equivalent substitutions, improvements and the like made within the spirit and the principle of the present application fall within the scope of the claims of the present application.

1. A method for manufacturing a non-stick inner pot, comprising:
providing a composite metal sheet comprising at least an outer metal layer, a heat equalization layer, and an inner metal layer; performing etching, engraving, or pressing on a side of the metal sheet where the inner metal layer is located, to form an anti-stick array, wherein the anti-stick array comprises a plurality of grooves or protrusions;
stretching the metal sheet with the anti-stick array under a controlled stretching rate to form the inner pot; or, first stretching the metal sheet under a controlled stretching rate to form an inner pot blank, and then bulging the inner pot blank under a controlled bulging rate to form the inner pot; wherein
a ratio of a thickness of a side wall to a thickness of a bottom wall of the manufactured inner pot ranges from 0.9 to 1.1, and a ratio of a thickness of the outer metal layer to a thickness of the inner metal layer ranges from 0.6 to 1.4, to make one part of the plurality of grooves or protrusions, which are deformed by stretching, in the anti-stick array meet a preset requirement, and wherein the preset requirement comprises: the one part of the plurality of grooves or protrusions, which are deformed by stretching, in the anti-stick array are located on the side wall, and a deformation ratio of the one part of the plurality of grooves or protrusions in an axial direction of the side wall of the inner pot ranges from 1.1 times to 1.8 times.

2. The method for manufacturing the non-stick inner pot according to claim 1, wherein a deformation ratio of the one part of the plurality of grooves or protrusions in a circumferential direction of the side wall of the inner pot ranges from 0.5 times to 1.01 times.

3. The method for manufacturing the non-stick inner pot according to claim 1, wherein the remaining part of the plurality of grooves or protrusions are located on the bottom wall of the inner pot, an equivalent diameter D of each of the remaining part of the plurality of grooves or protrusions and the thickness H1 of the inner metal layer satisfy the following relationship: 0.08≤D/H1≤3.

4. The method for manufacturing the non-stick inner pot according to claim 1, wherein a maximum diameter of each of the one part of the plurality of grooves on the side wall of the inner pot which are deformed is smaller than or equal to 1620 micrometers.

5. The method for manufacturing the non-stick inner pot according to claim 1, wherein a minimum diameter of each of the one part of the plurality of grooves or protrusions on the side wall of the inner pot which are deformed is greater than or equal to 50 micrometers.

6. The method for manufacturing the non-stick inner pot according to claim 1, wherein a ratio of the thickness of the outer metal layer to a thickness of the metal sheet ranges from 0.2 to 0.4.

7. The method for manufacturing the non-stick inner pot according to claim 1, wherein a ratio of the thickness of the inner metal layer to a thickness of the metal sheet ranges from 0.1 to 0.4.

8. The method for manufacturing the non-stick inner pot according to claim 1, wherein a ratio of a thickness of the heat equalization layer to a thickness of the metal sheet ranges from 0.2 to 0.7.

9. The method for manufacturing the non-stick inner pot according to claim 1, wherein the plurality of grooves in the anti-stick array are single pits being independent from one another and not in communication with one another, and a portion of the anti-stick array being located at a central region of the bottom wall of the inner pot covers a temperature measurement device.
